(19) United States
(12) Patent Application Publication
(10) Pub. No.: US 2025/0269805 A1
(43) Pub. Date: Aug. 28, 2025

(54) VEHICLE INTERIOR COVER WITH VENTILATION ACCESS

(71) Applicant: 4Knines, LLC, Oklahoma City, OK (US)

(72) Inventor: James Umlauf, Glendale, AZ (US)

(21) Appl. No.: 18/584,753

(22) Filed: Feb. 22, 2024

(51) Int. Cl. B60R 13/01

(52) U.S. Cl. CPC B60R 13/011

(57) ABSTRACT

Systems and methods of providing a vehicle cover are disclosed. In some implementations, the vehicle cover is configured to be disposed on a floor of a vehicle, between a front seat and a rear seat of the vehicle, in a substantially U-shaped configuration. The vehicle cover can include a front portion, a rear portion, a floor portion, and a vent port. In some cases, when the vehicle cover is disposed between the front seat and the rear seat of the vehicle in the substantially U-shaped configuration, the front portion can be disposed proximate the front seat, the rear portion can be disposed proximate the rear seat, the floor portion can be disposed proximate the floor, and the vent port can be positioned seat such that ventilation can pass through the vent port.

### FIELD OF THE INVENTION

The present disclosure relates to covers for vehicle interiors, such as protective covers for shielding seats, floors, and other vehicle components against dirt, damage, spills, mess from pets, and other things that might decrease the vehicle's value.

### BACKGROUND OF THE INVENTION

Vehicle interiors are often vulnerable to damage and dirtying from a variety of sources. For example, pets, children, cargo, and ordinary use can cause scratches, tears, stains, and other types of wear. To address these challenges, seat covers have been created to cover portions of vehicle interiors that are particularly susceptible to damage.

Unfortunately, many seat covers have drawbacks of their own. For example, many seat covers do not fit well with a variety of vehicle types, or can only be used in limited ways. Some seat covers are made of cheap materials that cannot protect the vehicle from spills, pet scratches, or other types of damage. Some seat covers block functionality of the vehicle, such as access to air vents, seatbelts, armrests, cupholders, or other car components. Accordingly, some seat covers are uncomfortable for pets or other users, particularly where air flow is blocked.

Many types of vehicle covers are limited to protecting seats only, leaving other portions of the vehicle interior (such as floors, doors, and backs of chairs) unprotected. Some seat covers are also difficult to keep in place, and they can shift while in use.

In light of these and other challenges, the vehicle cover industry could benefit from new vehicle interior covers with expanded comfort and functionality.

### BRIEF SUMMARY OF THE INVENTION

Systems and methods for providing new interior vehicle covers with expanded comfort and functionality are disclosed. In some implementations of the invention, an interior cover for a vehicle is provided. Some implementations of the interior cover are configured to form a general “hammock” shape, for example by including a front portion (configured to abut the back of the vehicle's front row of seats), a rear portion (configured to abut the bottom of the vehicle's back row of seats when such seats are in a stowed configuration), and a floor portion (disposed between the front and rear portion, and being configured to protect the floor of the vehicle).

In some implementations, the front portion includes a first coupler configured to couple the front portion to a front seat of the vehicle, and in some cases the rear portion includes a second coupler configured to couple the rear portion to a rear seat of the vehicle. In some implementations, at least one of the first coupler and the second coupler is configured to couple to a headrest.

In some implementations, the floor portion of the interior cover is configured to rest on the floor of the vehicle. In some implementations, the floor portion is (additionally or alternatively) configured to rest on a seat cushion of a rear vehicle seat. In some cases, the interior cover is adjustable so that the floor portion can be disposed in a manner convenient to the user. In some cases, one or more portions of the interior cover (e.g., the rear portion) includes one or more slits configured to allow the rear seat to selectively move between a stowed position and a deployed position. Some implementations of the slit include one or more fasteners for selectively opening and closing the slit.

Some implementations of the interior cover include one or more side flaps configured to help keep the interior cover from shifting with respect to the vehicle.

Some implementations of the interior cover include a window configured to be disposed between a driver-side front seat and a passenger-side front seat. In some cases, the window includes a mesh screen, and in some cases the window is configured to be selectively opened and closed.

In some implementations, the interior cover includes one or more air-permeable vent ports (e.g., for allowing ventilation to circulate). While the vent port can be formed in any portion of the interior cover, some implementations include the vent port formed in the front portion. In some cases, the vent port is disposed at a base of the front portion. In some cases, the vent port is configured to be disposed behind at least one of a driver-side front seat and a passenger side front seat (to thereby allow air to flow from beneath such seats and into the “hammock” portion of the cover). In some implementations, the vent port has a mesh screen, and in some implementations the vent port has a cover configured to be selectively opened and closed to selectively permit ventilation to pass through the vent port. Some implementations of the vent port include one or more fasteners configured to selectively retain the cover in at least one of an opened position and a closed position.

Some implementations of the invention include a method of forming an interior cover for a vehicle. In some cases, the method includes forming an interior cover body having a front portion, a rear portion, and a floor portion. Some implementations include forming an air-permeable vent portion in at least one of the front portion, the rear portion, and the floor portion.

In some implementations, forming the interior cover body includes forming multiple layers. For example, in some cases the method includes obtaining one or more of a first layer of polyester material, a layer of cotton material, a first layer of non-slip material, a layer of waterproof film material, a second layer of polyester material, and a second layer of non-slip material. Some implementations of the method include quilting together two or more of the first layer of polyester material, the layer of cotton material, and the first layer of non-slip material to form a quilted assembly. Some implementations include bonding together two or more of the layer of waterproof film material, the second layer of polyester material, and the second layer of non-slip material to form a bonded assembly. Some implementations include coupling a perimeter (or another portion) of the quilted assembly to a perimeter (or another portion) of the bonded assembly. In some cases, at least a portion of the mesh screen is interposed between two or more of these layers. Additional systems and methods and modifications thereto are also disclosed.

### BRIEF DESCRIPTION OF THE DRAWINGS

The objects and features of the present disclosure will become more fully apparent from the following description and appended claims, taken in conjunction with the accompanying drawings. Understanding that these drawings depict only typical embodiments of the disclosed systems and methods and are, therefore, not to be considered limiting of its scope, the systems and methods will be described and explained with additional specificity and detail through the use of the accompanying drawings in which:

FIG. 1 shows a front perspective view of an interior cover in a hammock configuration in accordance with a representative embodiment of the disclosed systems and methods;

FIG. 2 shows a front perspective view of an interior cover with an alternative vent port in a hammock configuration in accordance with a representative embodiment;

FIG. 3 shows a side perspective view of an interior cover installed in a vehicle in accordance with a representative embodiment;

FIG. 4 shows a partial perspective view of a front portion of an interior cover installed in a vehicle in accordance with a representative embodiment;

FIG. 5 shows a partial perspective view of a rear portion of an interior cover installed in a vehicle in accordance with a representative embodiment;

FIG. 6 shows a plan view of an interior cover in a flat configuration in accordance with a representative embodiment;

FIG. 7 shows a front view of a vent port of an interior cover in accordance with a representative embodiment; and

FIG. 8 shows an exploded perspective view of various layers of material used in an interior cover in accordance with a representative embodiment.

FIG. 9 shows a plan view of an interior cover having an alternative configuration, in accordance with a representative embodiment.

FIG. 10 shows a perspective view of a portion of an interior cover having lateral couplers, in accordance with a representative embodiment.

### DETAILED DESCRIPTION OF THE INVENTION

Presently preferred embodiments of the present invention will be best understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

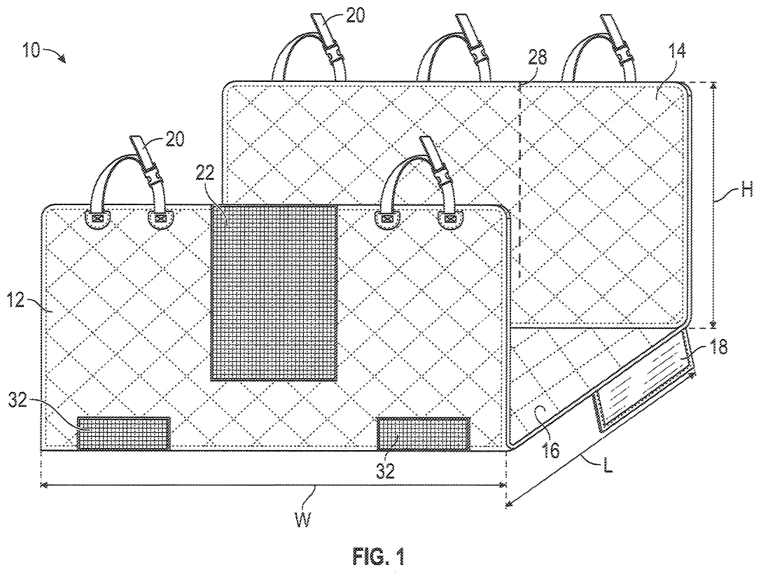

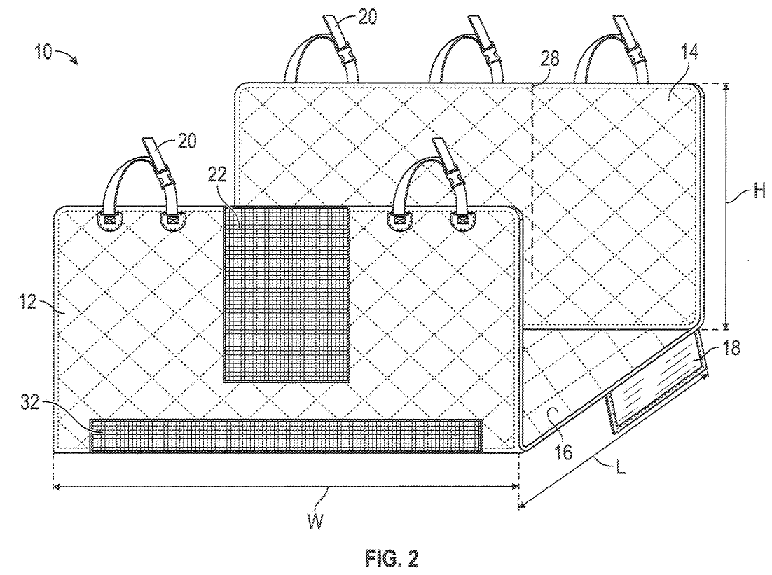

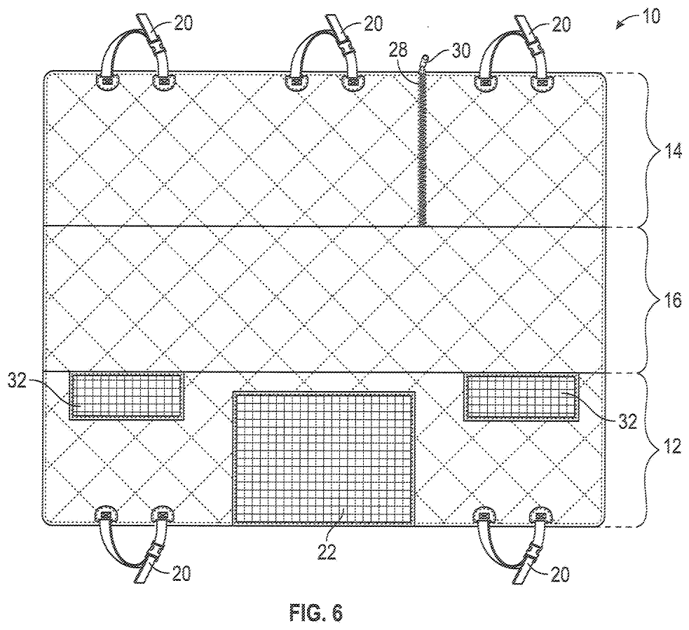

As shown generally in FIGS. 1-6, some embodiments of the present invention include an interior cover 10 for protecting (or making more comfortable) one or more portions of an interior of a vehicle. In some embodiments (as seen, for example, in FIG. 6), a main body of the cover 10 is divided into three main sections, including a front portion 12, a rear portion 14, and a floor portion 16. Although the various portions of the cover can be arranged in any suitable manner, some embodiments of the cover 10 (as shown in FIGS. 1-2) are configured to adopt a “hammock” or “taco” configuration, where the front portion 12 and the rear portion 14 form walls, while the floor portion 16 forms a floor, overall forming a general hammock shape with an interior defined by the front portion, rear portion, and floor portion.

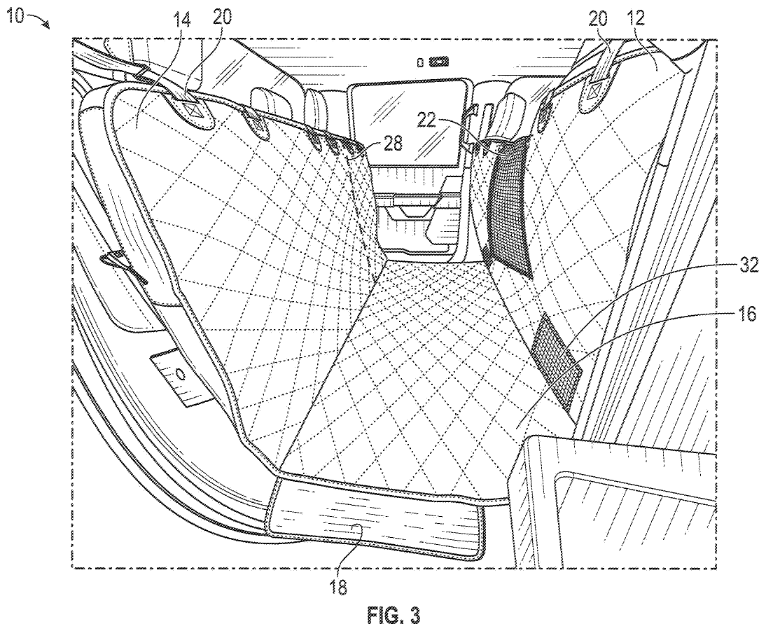

As shown by FIG. 3, some embodiments of the cover are configured to be installed in a vehicle. The cover can be installed in a vehicle in any manner useful for protecting (or rendering more comfortable) any portion of the interior of the vehicle. That said, some embodiments of the cover are configured to be installed in the hammock configuration discussed above in the space between rows of seats in a vehicle (or between a row of seats and another portion of the vehicle, such as a back door). In particular, in some embodiments, the front portion 12 is configured to be disposed proximate the rear of one or more front seats of the vehicle. In some embodiments, the rear portion 14 is configured to be disposed proximate a row of back seat of a vehicle (for example, in vehicles in which the back row of seat cushions is designed to fold up, the rear portion can be disposed adjacent to the bottoms of the folded seats). In some embodiments, the floor portion is configured to be disposed proximate the floor of the vehicle (e.g., resting on the floor or suspended above the floor). As an alternative installation, the floor portion can rest on the seat cushions of the rear seat, and the rear portion can be disposed proximate the backrests of the rear seat.

With reference to FIGS. 1-3 (and as also seen in FIG. 6), some embodiments of the cover 10 include components for maintaining the position of the cover relative to the vehicle. For example, some embodiments include a side flap 18. The side flap can include any component useful for preventing or reducing lateral movement of the cover, such as one or more flaps, straps, hooks, cords, fasteners, or other components that can be attached to or disposed between portions of the vehicle. For example, in some embodiments the side flaps include extensions of the main body of the cover, which can be placed near the doors of the vehicle (or even configured to become secured in place between the car doors and the car body). In some cases, the side flaps include fasteners configured to attach to the car doors or another part of the car. Although some embodiments of the side flaps are disposed on the floor portion 16 of the cover, the side flaps can additionally or alternatively be disposed on the front portion, the rear portion, or any other part of the cover, in any position or orientation. Furthermore, although the side flaps can have any suitable dimensions, some embodiments of the side flap have a length that is less than the length of the floor portion (i.e., the distance between the front portion and the rear portion). In some cases, the side flaps have a width (i.e., the distance that the side flap extends outward away from the cover) between 10 cm and 1 m, or any subrange thereof. In some cases, the width of the side flap is about 30 cm±15 cm, which allows it to secure the cover in place without being overly cumbersome.

In a similar vein, some embodiments of the cover 10 include one or more couplers 20. The couplers can include any components useful for attaching one or more portions of the cover to one or more portions of the vehicle. For example, the couplers can include one or more straps, buckles, hooks, eyelets, magnets, hook-and-loop fasteners, adhesives, snaps, ties, or any other types of couplers. As an example, some embodiments of the coupler include a component configured to couple to a headrest. In some cases, such a component includes a first strap having a fastener and a second strap having a complementary fastener configured to couple to the fastener (e.g., a hook-and-loop fastener, a buckle), with one end of each strap being spaced apart and anchored to the cover, such that the other ends can be coupled together around the headrest for a convenient attachment. In some cases, the straps are anchored to the cover with a reinforced anchoring to prevent tearing or separation from the cover. In some embodiments, the couplers are selectively removable from the cover (e.g., by being coupled to the cover with a removable fastener, such as a hook-and-loop fastener).

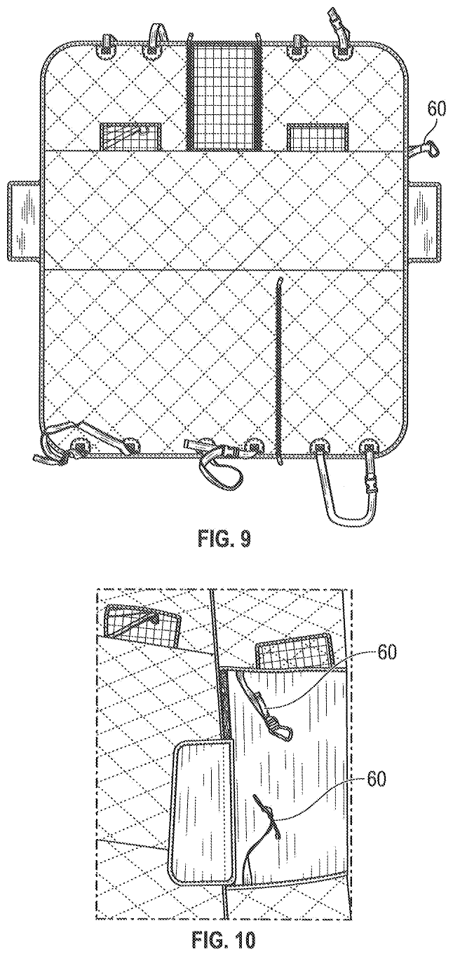

Although the couplers 20 can include any suitable couplers attached (selectively, permanently, or semi-permanently) to any portion of the cover 10, some embodiments include lateral couplers 60 attached (selectively, permanently, or semi-permanently) to a desired portion of the cover (as shown in FIGS. 9-10). In this regard, some vehicle covers have a tendency to shift around, flap, vibrate, or catch air currents when one or more windows of the vehicle are opened. Lateral couplers 60 coupled to the floor portion 16 of the cover (e.g., near the side flap 18) can help prevent the cover from shifting, flapping, vibrating, or otherwise being disrupted due to air flow. Thus, some embodiments include lateral couplers coupled to the floor portion (which, like any of the other couplers 20 discussed herein, can have any suitable strap features (e.g., straps, ropes, cords, clips, ratchets, etc.) and any suitable anchor features (clips, hooks, fasteners, nails, screws, bolts, staples, eyelets, magnets, hook-and-loop fasteners, adhesives, welds, interference fits, friction fits, tongue-and-groove connections, snaps, ties, rivets, stakes, carabiners, or any other coupling mechanisms). In some embodiments, one or more of the lateral anchors are coupled to a perimeter of the cover (and in some embodiments, one or more lateral anchors are connected to a portion of the cover away from the perimeter). In some embodiments, one or more lateral anchors are configured to attach to one or more of the following components of a car: a runner or track (often found on the exterior of a vehicle, can be used as a step), a plate or frame portion, a door or a component of a door, a seatbelt anchor, or another portion of a vehicle.

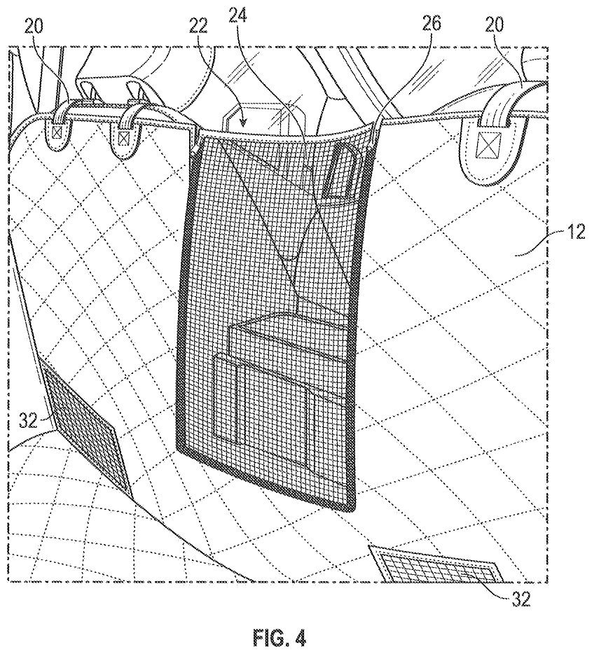

As best seen in FIG. 4 (and as also shown in FIGS. 1-3 and 6), some embodiments of the cover 10 include one or more windows 22. Although the window can be placed anywhere on the cover where a window may be desirable, in some embodiments the window is formed in the front portion 12 of the cover, approximately in the middle, thereby allowing for a passage between the driver-side front seat and the passenger-side front seat (e.g., so a person or pet can see into the front row, receive ventilation from the front row, more easily communicate with persons in the front row, move items back and forth between the front row, or otherwise interface with the front row more easily than could be accomplished without the window).

The window 22 can have any suitable dimensions (e.g., anywhere between 10 cm and 2 m in width or height, or any subrange thereof, or taking up any percentage of the cover's area, such as 1-30%, or any subrange thereof), but in some cases the window has a width that is approximately one third of the width of the cover (or less), and a height that is greater than half the height of the front portion 12, but (in some cases) less than the full height of the front portion (e.g., to provide a large amount of window space, while still accounting for and protecting the front seats and a center console that is often disposed between the front seats, as shown in FIGS. 1-4). That said, in some embodiments, the window extends across a full height of the front portion (as shown in FIG. 9).

In some embodiments, the window 22 includes a window mesh 24. The window mesh can include any type of mesh, including air-permeable mesh, stretch mesh, polyester mesh, hex mesh, cargo mesh, or any other type of mesh fabric (of any grade or size). In some cases, (instead of or in addition to the window mesh) the window includes a window cover, which can be transparent, translucent, or opaque, and constructed of any suitable material (e.g., plastic, canvas, cotton, polyester, or layered material of the same as or a different kind than the body of the cover).

In some embodiments, the window 22 (or the window cover) is configured to selectively open and close. Accordingly, some embodiments include a window fastener 26, which can include any component that allows the window to selectively open and close (partially or completely). For example, in some embodiments, a zipper (or a hook-and-loop fastener or another type of fastener) circumscribes a perimeter of the window.

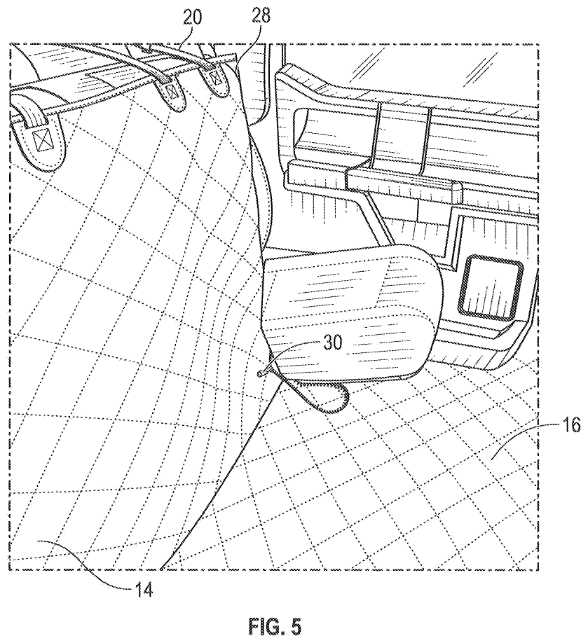

As shown in FIGS. 1, 2, and 6, some embodiments of the cover 10 include a slit 28. In some embodiments, the slit (as shown in FIG. 5) can allow for adjustment of the seats of the vehicle. For example, in some embodiments, the slit allows for a seat cushion (or for an armrest, a seat back, or another component) to be folded down. In some embodiments, the slit allows for a seatbelt (or a buckle or another seatbelt component) to be used notwithstanding the installation of the cover. Although some embodiments of the slit are formed in the rear portion 14 of the cover, the slit can also be formed in the front portion 12, the floor portion 16, or any other portion of the cover (at any position and in any orientation, as useful to allow various vehicle components to be used notwithstanding the presence of the cover).

Some embodiments of the slit 28 include a slit fastener 30. The slit fastener can include any suitable fastener, including one or more eyelets, hooks, magnets, hook-and-loop fasteners, adhesives, interference fits, friction fits, tongue-and-groove connections, snaps, ties, or any other type of fastener (but particularly selectively engageable fasteners). As one non-limiting example, the slit fastener may include a zipper. The zipper can be a double-sided zipper (or another type of double-sided fastener), thereby allowing for the bottom portion of the slit to be unzipped (and a seatbelt or another component to protrude therethrough) while the remainder of the slit remains closed.

Although the window 22 or the slit 28 could potentially be helpful in allowing some amount of ventilated air reach the interior of the hammock (when the cover is in the hammock configuration and installed in a vehicle), often times vehicles are configured to provide ventilation to the feet of users by blowing air underneath the seats. Indeed, many models of vehicles include vents or air conduits underneath the seats of the front row (or other rows of seats). Due to the hammock-like configuration of the cover 10, certain configurations could tend to block some or all of this airflow. Accordingly, some embodiments of the cover include one or more vent ports 32, as shown in FIGS. 1-4 and 6-7.

The vent port 32 can include any component configured to allow for ventilation access, such as a port mesh 34. The port mesh can include any type of mesh, including any type of mesh that can be used for the window mesh 24 (as discussed above). Where both a window mesh and a port mesh are used, the two meshes can be the same or different. Indeed, in some cases it may be desirable to use a smaller grade mesh for the port mesh, as the vent ports may be positioned closer to the floor, and therefore may be more likely to encounter dirt, hair, crumbs, or other fallen particulates, and a smaller grade mesh may be more effective at blocking such particulates from entering the vent port. In some embodiments, the port mesh is waterproof or water-repellant (e.g., due to the material, the weave, the presence of a waterproof coating, or another type of waterproofing) to prevent or limit spills from entering the vent port. Indeed, in some embodiments, the port mesh includes a particular weave, grade, material, or coating, or combination thereof, to produce an air-permeable vent port that is not also water-permeable (or that is less water-permeable).

In some embodiments, the port mesh 34 may be configured to selectively open and close (e.g., by way of a fastener, such as a zipper or another fastener that can be used for selectively opening and closing the window 22), but in some embodiments the port mesh is not configured to open. Indeed, in some cases the port mesh is fixedly closed, thereby reducing the possibility of an accidental opening that might lead to hair, dust, debris, crumbs, spills, or other materials making their way into the vent port, and further removing bulky fasteners that could get caught on pets, people, or objects.

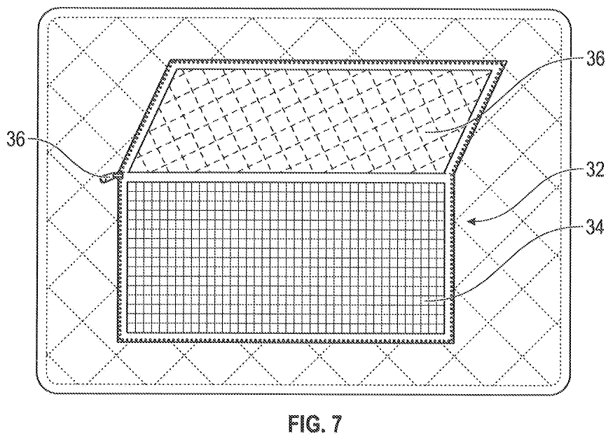

Although some embodiments of the vent port 32 do not include additional materials beyond a simple opening or a port mesh 34, some embodiments of the vent port include a port cover (e.g., the port cover 36 as shown in FIG. 7). Where the vent port includes a port cover, the port cover can include any component configured to fully or partially cover the vent port. For example, the port cover can include one or more pieces of material (e.g., plastic, cotton, polyester, cloth, layered material like that which forms some embodiments of the cover, or any other material). In some embodiments, the port cover includes a cover fastener 38 configured to enable the port cover to be selectively opened and closed. In some cases, the fastener includes a zipper, a hook-and-look fastener, or another fastener around part or all of a perimeter of the port cover. In some embodiments, the fastener includes a tie, a snap, or another type of fastener for holding the port cover open (e.g., the port cover can be a simple flap with a snap or another fastener attached thereto, the snap or other fastener being configured to couple the flap to a portion of the cover disposed near the port).

The vent port 32 can be positioned anywhere on the cover 10 (e.g., on the front portion 12, the rear portion 14, the floor portion 12, or multiple of the foregoing). That said, in some embodiments the vent port is positioned proximate one or more vents or air streams, such as vents or air streams positioned under vehicle seats. Indeed, in some embodiments the vent port is positioned such that when the cover is installed in a vehicle, the vent port is aligned with a space under a driver-side or passenger-side front seat (or, where multiple vent ports or a long very port are used, aligned with spaces under each of the front-row seats). Described with respect to the rest of the cover, in some embodiments, the vent port is positioned proximate (e.g., at or near) a lateral edge of the front portion, and proximate the floor portion. Indeed, as shown in FIG. 6, some embodiments of the vent port are positioned such that a lower edge of the vent port 32 is near or in contact with a lower edge of the front portion 12 (or a front edge of the floor portion 16). In some embodiments, at least a portion of the vent port is positioned lower (e.g., closer to the floor portion) on the front portion than a bottom edge of the window 22. That said, in some embodiments, a bottom portion of the window can be positioned near the bottom edge of the front portion 12 (as shown in FIG. 9). Accordingly, the bottom portion of the window in such embodiments can act as a vent port for an air current that might pass underneath a central seat (for vehicles that have a central seat).

With reference to FIGS. 1 and 2, the vent port 32 can have any suitable dimensions. In some cases, multiple vent ports are used to provide ventilation access to multiple areas of the cover (as shown in FIG. 1), and in some cases a single long vent port is used to a similar effect. The vent port can also have any other suitable shape or configuration. For example, the vent port can be rectangular, square, oval, triangular, polygonal, or any other shape. The vent port can run generally parallel to the edges of the cover 10, or it can be slanted, angled, curved, perpendicular, or otherwise positioned with respect to the cover. In some cases, the vent port is aligned with a particular vent for a particular car model. Moreover, while the vent port can be any size, in some embodiments the vent port is approximately the same size as a corresponding vent or air stream. In some cases, the vent port is smaller than the corresponding vent or air stream (e.g., the vent port is smaller than the space under the seat of the vehicle) so that the corresponding air flow is augmented by the constriction.

The vent port 32 can be integrated into the cover 10 in any suitable manner. For instance, in some cases the vent port includes a hole or passage cut through all or part of the cover. In some cases, the port mesh 34 is sewn, adhered, or otherwise attached to a perimeter of the hole or passage. In some embodiments, the port mesh is integrated between two or more layers of the cover body (as described in additional detail below).

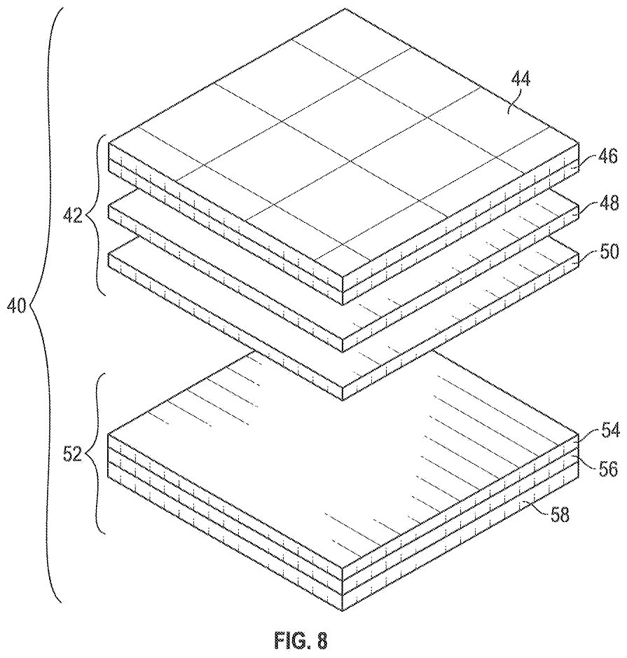

Turning now to FIG. 8, the material of the cover body 40 can include any material or materials (blended or provided in layers) suitable for providing a protective or comfortable cover. For example, the cover body can include one or more of the following materials: cotton, polyester, waterproof material, synthetic fiber, plastic, carbon fiber, polymer material, cardboard, paper, nylon, linen, satin, crepe, chiffon, silk, leather, velvet, wool, canvas, muslin, denim, other fabric, netting, mesh, or any other material.

In some embodiments, the cover body 40 includes one or more quilted layers 42 and one or more bonded layers 52. The quilted layers may be connected to each other through quilting, stitching, sewing, or other needlework in any pattern or manner. The bonded layers may be connected to each other through any type of adhesive, heat bonding, chemical bonding, or any other type of bonding. The use of a quilted layer together with a bonded layer can result in a comfortable, durable, and waterproof cover of high quality. While the quilted layer and the bonded layer can be attached together in any suitable manner, in some embodiments they are attached together only at a perimeter (although in some embodiments, they are attached together at one or more points in the middle as well).

In some embodiments, the quilted layer 42 includes one or more waterproof coatings 44, one or more layers of polyester material 46, one or more layers of cotton material 48, one or more layers of non-slip material 50, or any other material layers. In some embodiments, the waterproof coating is disposed on the top of the quilted layer (to therefore become an exterior surface of the cover). In some embodiments, the non-slip layer is disposed on the bottom of the quilted layer (to prevent slippage between the quilted layer and the bonded layer, as some embodiments of the cover body are not attached together at one or more middle portions of the quilted layer and bonded layer).

In some embodiments, the bonded layer 52 includes one or more waterproof films 54, layers of polyester 56, layers of non-slip material 58, or any other layers of material. In some embodiments, the waterproof film is disposed on the top of the bonded layer (thereby being disposed on the interior of the cover body 40, in some cases proximate the non-slip material 50 of the quilted layer 42). This way, the waterproof film can stop any liquid that manages to make its way through the quilting of the quilted layer. In some embodiments, the non-slip material of the bonded layer is disposed on the bottom of the bonded layer, thereby providing a non-slip surface that can be disposed on surfaces of the vehicle (parts of car seats, the car floor, etc.) to further keep the cover from shifting with respect to the vehicle.

Some embodiments of the disclosed systems and method include a method of forming the cover 10 or various embodiments thereof, as discussed above or as shown in any of FIGS. 1-8. According to some embodiments, the method can include forming or otherwise obtaining any of the components of the cover discussed herein, such as one or more front portions 12, rear portions 14, floor portions 16, side flaps 18, couplers 20, windows 22, window meshes 24, window fasteners 26, slits 28, slit fasteners 30, vent ports 32, port meshes 34, port covers 36, cover fasteners 38, cover bodies 40, quilted layers 42, waterproof coatings 44, first layers of polyester material 46, layers of cotton material 48, first layers of non-slip material 50, bonded layers 52, layers of waterproof film 54, second layers of polyester material 56, second layers of non-slip material 58, or any other suitable components.

Some embodiments of the method include forming the cover body 40 having the front portion 12, the rear portion 14, and the floor portion 16. In some embodiments, this includes dividing the cover 10 into the various portions (e.g., through folding and pressing to create a crease, through stitching to form a dividing seam, or otherwise dividing the cover into the portions). In some embodiments, forming the cover body includes obtaining the front portion, the rear portion, and the floor portion as separate pieces and subsequently coupling them together. In some cases, the sectioning of the cover body is such that the portions where sections meet are easily folded (thus allowing the cover to easily adopt the hammock configuration), but the individual sections are more resistant to folding (thus resulting in smoother cover surfaces).

In some embodiments, the method includes coupling the various layers together to form the cover body 40. For example, some embodiments of the method include quilting together the first layer of polyester material 46, the layer of cotton material 48, and the first layer of non-slip material 50 to form the quilted layer 42. Some embodiments include bonding together the layer of waterproof film material 54, the second layer of polyester material 56, and the second layer of non-slip material 58 to form a bonded assembly. Some embodiments include coating one or more layers with the waterproof coating 44 (such as, but not limited to, the first layer of polyester material). In some embodiments, the method includes coupling a perimeter of the quilted assembly to a perimeter of the bonded assembly (e.g., through stitching, use of an adhesive, attaching a perimeter liner, or through another coupling).

Some embodiments of the method include forming an air-permeable vent port 32 in the cover. This can include forming the vent port in any configuration or position as discussed above. As an example, in some embodiments the vent port is formed in the front portion 12, in some cases proximate the floor portion, and in some cases proximate or spaced apart from a lateral edge of the cover. In some embodiments, forming the vent port includes forming a passage through one or more layers of the cover (such as by cutting a hole therethrough). In some embodiments, the method further includes stitching or creating a seam (or otherwise coupling the layers together) around a perimeter of the vent port to prevent fraying at the edges, and to further attach the layers of the cover together at the vent port perimeter.

In some embodiments, the hole is only partially cut such that one or more edges of the vent port 32 remains attached to the remainer of the cover 10, thereby forming the port cover 36. In some embodiments, the port cover is further sewn or otherwise coupled around the perimeter (or a portion thereof), or a cover fastener 38 is attached thereto.

Some embodiments include forming a mesh screen and coupling the mesh screen to the perimeter of the passage of the vent port 32 to form the port mesh 34. In some embodiments, the mesh screen is simply sewn, adhered, or otherwise coupled to a perimeter of the vent port 32, but in some cases at least one of the edges of the port mesh 34 is interposed between one or more layers of the cover body 40 (e.g., between the quilted layer 42 and the bonded layer 52, between the first layer of polyester material 46 and the layer of cotton material 48, between the second layer of polyester material 56 and the second layer of non-slip material 58, or between any other layers) before said layers are coupled together, thus securing the port mesh in place at the time of the coupling. In some embodiments, mesh is included throughout all or part of the cover body, and only the other layers are cut away at the vent port, thereby leaving the integrated port mesh exposed.

Any and all of the components in the figures, embodiments, implementations, instances, cases, methods, applications, iterations, and other parts of this disclosure can be combined in any suitable manner. Additionally, any component can be removed, separated from other components, modified with or without modification of like components, or otherwise altered together or separately from anything else disclosed herein.

As used herein, the singular forms “a”, “an”, “the” and other singular references include plural referents, and plural references include the singular, unless the context clearly dictates otherwise. For example, reference to a vent port includes reference to one or more vent ports, and reference to fasteners includes reference to one or more fasteners. In addition, where reference is made to a list of elements (e.g., elements a, b, and c), such reference is intended to include any one of the listed elements by itself, any combination of less than all of the listed elements, and/or a combination of all of the listed elements. Moreover, the term “or” by itself is not exclusive (and therefore may be interpreted to mean “and/or”) unless the context clearly dictates otherwise. Similarly, the term “and” by itself is not exclusive (and therefore may be interpreted to mean “and/or”) unless the context clearly dictates otherwise. Furthermore, the terms “including”, “having”, “such as”, “for example”, “e.g.”, and any similar terms are not intended to limit the disclosure, and may be interpreted as being followed by the words “without limitation”.

In addition, as the terms “on”, “disposed on”, “attached to”, “connected to”, “coupled to”, etc. are used herein, one object (e.g., a material, element, structure, member, etc.) can be on, disposed on, attached to, connected to, or otherwise coupled to another object-regardless of whether the one object is directly on, attached, connected, or coupled to the other object, or whether there are one or more intervening objects between the one object and the other object. Also, directions (e.g., “front”, “back”, “on top of”, “below”, “above”, “top”, “bottom”, “side”, “up”, “down”, “under”, “over”, “upper”, “lower”, “lateral”, “right-side”, “left-side”, “base”, etc.), if provided, are relative and provided solely by way of example and for ease of illustration and discussion and not by way of limitation.

The described systems and methods may be embodied in other specific forms without departing from their spirit or essential characteristics. The described embodiments, examples, and illustrations are to be considered in all respects only as illustrative and not restrictive. The scope of the described systems and methods is, therefore, indicated by the appended claims rather than by the foregoing description. All changes that come within the meaning and range of equivalency of the claims are to be embraced within their scope. Moreover, any component and characteristic from any embodiments, examples, and illustrations set forth herein can be combined in any suitable manner with any other components or characteristics from one or more other embodiments, examples, and illustrations described herein.

What is claimed is:

1. An interior cover for a vehicle, the interior cover comprising:
a front portion having a first coupler configured to couple the front portion to a front seat of the vehicle, the front portion being configured to protect the front seat;
a rear portion having a second coupler configured to couple the rear portion to a rear seat of the vehicle, the rear portion being configured to protect the rear seat;
a floor portion disposed between the front portion and the rear portion, the floor portion being configured to protect the floor of the vehicle; and
an air-permeable vent port.

2. The interior cover of claim 1, wherein the floor portion is configured to rest on the floor of the vehicle.

3. The interior cover of claim 1, wherein at least one of the first coupler and the second coupler is configured to couple to a headrest.

4. The interior cover of claim 1, further comprising at least one of a side flap and a lateral coupler configured to prevent or resist the interior cover's shifting with respect to the vehicle.

5. The interior cover of claim 1, further comprising a window configured to be disposed between a driver-side front seat and a passenger-side front seat.

6. The interior cover of claim 5, wherein the window comprises a mesh screen.

7. The interior cover of claim 6, wherein the window is configured to be selectively opened and closed.

8. The interior cover of claim 1, further comprising a slit configured to allow the rear seat to selectively move between a stowed position and a deployed position.

9. The interior cover of claim 8, wherein the slit comprises a fastener for selectively opening and closing the slit.

10. The interior cover of claim 1, wherein the vent port is formed in the front portion.

11. The interior cover of claim 10, wherein the vent port is disposed at a base of the front portion.

12. The interior cover of claim 11, wherein the vent port is configured to be disposed behind at least one of a driver-side front seat and a passenger side front seat.

13. The interior cover of claim 1, wherein the vent port comprises a mesh screen.

14. The interior cover of claim 1, wherein the vent port comprises a cover configured to be selectively opened and closed to selectively permit ventilation to pass through the vent port.

15. The interior cover of claim 14, wherein the cover comprises a fastener configured to selectively retain the cover in at least one of an opened position and a closed position.

16. A method of forming an interior cover for a vehicle, the method comprising:
forming an interior cover body having a front portion, a rear portion, and a floor portion; and
forming an air-permeable vent port in the front portion of the interior cover body.

17. The method of claim 16, wherein the forming the interior cover body comprises:
obtaining a first layer of polyester material, a layer of cotton material, a first layer of non-slip material, a layer of waterproof film material, a second layer of polyester material, and a second layer of non-slip material;
quilting together the first layer of polyester material, the layer of cotton material, and the first layer of non-slip material to form a quilted assembly;
bonding together the layer of waterproof film material, the second layer of polyester material, and the second layer of non-slip material to form a bonded assembly; and
coupling a perimeter of the quilted assembly to a perimeter of the bonded assembly.

18. The method of claim 17, wherein the forming the air-permeable vent port comprises:
cutting through one or more of the layers of material forming the interior cover body to form a passage through the interior cover body; and
coupling the quilted assembly to the bonded assembly at a perimeter of the passage.

19. The method of claim 18, wherein the forming the air-permeable vent port further comprises forming a mesh screen and coupling the mesh screen to the perimeter of the passage.

20. A vehicle cover configured to be disposed between a front seat and a rear seat of a vehicle in a substantially U-shaped configuration, the vehicle cover comprising:
a front portion;
a rear portion;
a floor portion; and
a vent port,
wherein when the vehicle cover is disposed between the front seat and the rear seat of the vehicle in the substantially U-shaped configuration, the front portion is disposed proximate the front seat, the rear portion is disposed proximate the rear seat, the floor portion is disposed proximate a floor of the vehicle, and the vent port is disposed proximate a bottom of the front seat such that ventilation can pass underneath the front seat and through the vent port.
